(19) United States
(12) Patent Application Publication
(10) Pub. No.: US 2020/0122311 A1
(43) Pub. Date: Apr. 23, 2020

(54) POWER TOOL

(71) Applicant: PANASONIC INTELLECTUAL PROPERTY MANAGEMENT CO., LTD., Osaka (JP)

(72) Inventors: Naoki TSURUTA, Mie (JP); Masaki IKEDA, Mie (JP)

(21) Appl. No.: 16/477,786

(22) PCT Filed: Dec. 26, 2017
(86) PCT No.: PCT/JP2017/046513

§ 371 Date: Jul. 12, 2019

(30) Foreign Application Priority Data
Jan. 13, 2017 (JP) 2017-004708

(51) Int. Cl. B25F 5/00; H01H 13/66

(52) U.S. Cl. CPC B25F 5/00; H01H 13/66

(57) ABSTRACT

A power tool includes a motor, a trigger, a pressure sensing unit, and a control circuit. The motor is configured to receive electric power from a battery to rotate a socket. The trigger is movably held by a tool body. The pressure sensing unit includes a pressure receiving unit for receiving pressure according to a pull-in amount of the trigger and is configured to measure a magnitude of the pressure received with the pressure receiving unit. The control circuit is configured to control a rotational speed of the motor based on measured pressure measured by the pressure sensing unit. The control circuit is configured to perform hysteresis control of the rotational speed of the motor such that the rotational speed of the motor with respect to the measured pressure differs between a case where the measured pressure increases with time and a case where the measured pressure decreases with time.

### TECHNICAL FIELD

The present disclosure generally relates to power tools, and more specifically to a power tool which includes a trigger.

### BACKGROUND ART

A power tool whose rotational speed of a motor is changed in accordance with the amount of displacement of a trigger has been disclosed (see, for example, Patent Literature 1). The power tool disclosed in Patent Literature 1 includes a speed change switch. The speed change switch includes a load sensor and a trigger that is to be pulled with a finger by a user. The load sensor is configured to output a voltage signal proportional to the pulling amount (pressing force) of the trigger. A control circuit part is configured to adjust, based on an output signal from the load sensor, electric power to be supplied to a DC motor by PWM control.

The output of the load sensor (pressure sensing unit) continuously changes in accordance with a change of the pulling amount (pull-in amount) of the trigger. Thus, for example, if during work with the power tool, the pull-in amount of the trigger is changed by vibration caused due to the work, the rotational speed of the motor may become unstable.

### CITATION LIST

### Patent Literature

Patent Literature 1: JP 2012-101326 A

### SUMMARY OF INVENTION

In view of the foregoing, it is an object of the present disclosure to provide a power tool configured to stabilize the rotational speed of a motor.

A power tool according to one aspect of the present disclosure includes a motor, a trigger, a pressure sensing unit, and a control circuit. The motor is configured to receive electric power from a power supply to rotate a tip tool. The trigger is movably held by a tool body. The pressure sensing unit includes a pressure receiving unit for receiving pressure according to a pull-in amount of the trigger and is configured to measure a magnitude of the pressure received with the pressure receiving unit. The control circuit is configured to control a rotational speed of the motor based on measured pressure measured by the pressure sensing unit. The control circuit is configured to perform hysteresis control of the rotational speed of the motor such that the rotational speed of the motor with respect to the measured pressure differs between a case where the measured pressure increases with time and a case where the measured pressure decreases with time.

### BRIEF DESCRIPTION OF DRAWINGS

FIG. 1 is a block diagram illustrating a power tool according to one embodiment of the present disclosure;

FIG. 2 is an exterior perspective view illustrating the power tool;

FIG. 3A is a simplified schematic view illustrating a state of a main switch and a pressure sensing unit when a trigger of the power tool is in an OFF position, and FIG. 3B is a simplified schematic view illustrating a state of the main switch and the pressure sensing unit when the trigger of the power tool is in an ON position; and

FIG. 4 is a graph illustrating characteristics of the rotational speed of a motor with respect to measured pressure in the power tool.

### DESCRIPTION OF EMBODIMENTS

An embodiment of the present invention will be described below with reference to the drawings. Note that the embodiment described below is a mere example of various embodiments of the present invention. Various modifications may be made to the embodiment described below depending on design and the like as long as the object of the present disclosure is achieved.

### EMBODIMENT

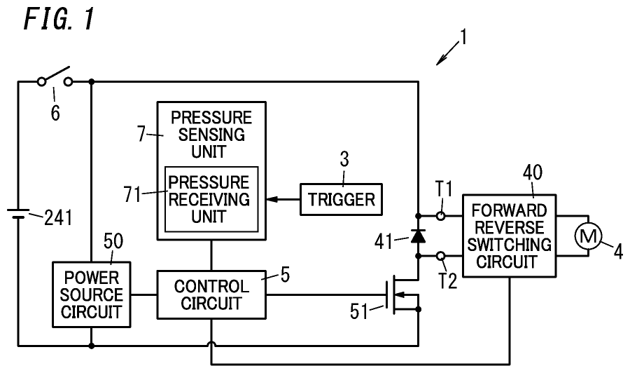

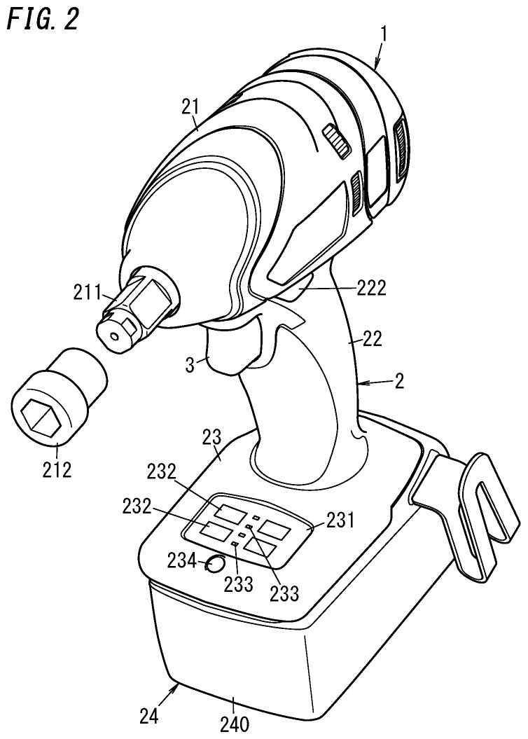

FIGS. 1 and 2 respectively show a block diagram and an exterior perspective view of a power tool 1 of the present embodiment. The power tool 1 of the present embodiment is, for example, an electric wrench used in fastening work of fastening components such as bolts and nuts.

As illustrated in FIG. 2, the power tool 1 includes a tool body 2. The tool body 2 includes a body section 21 having a tube shape, a grip 22 protruding from a peripheral surface of the body section 21 in a radial direction, and an attachment part 23 to which a battery pack 24 is detachably attached.

The body section 21 accommodates a motor 4. The motor 4 is, for example, a direct-current motor and is configured to rotate with electric power supplied from a battery 241 (power supply) included in the battery pack 24. The motor 4 is electrically connected to the battery 241 via a forward reverse switching circuit 40, a main switch 6, and a drive switch 51 (see FIG. 1).

The forward reverse switching circuit 40 includes a bridge circuit. The bridge circuit includes a plurality of switches. The forward reverse switching circuit 40 includes output terminals between which the motor 4 is electrically connected. The forward reverse switching circuit 40 switches the direction of a direct current supplied from the battery 241 to the motor 4 so as to switch the rotation direction of the motor 4 between forward rotation and reverse rotation. The forward reverse switching circuit 40 includes a positive-electrode-side input terminal T1 and a negative-electrode-side input terminal T2. The positive-electrode-side input terminal T1 is electrically connected via the main switch 6 to a positive electrode terminal of the battery 241. The negative-electrode-side input terminal T2 is electrically connected via the drive switch 51 to a negative electrode terminal of the battery 241. Moreover, between the positive-electrode-side input terminal T1 and the negative-electrode-side input terminal T2 of the forward reverse switching circuit 40, a regenerative diode 41 is electrically connected. The regenerative diode 41 has an anode electrically connected to the negative-electrode-side input terminal T2 and a cathode electrically connected to the positive-electrode-side input terminal T1.

The drive switch 51 includes, for example, an n-channel Metal Oxide Semiconductor Field Effect Transistor (MOSFET). The drive switch 51 has a drain terminal electrically connected to the negative-electrode-side input terminal T2 of the forward reverse switching circuit 40 and a source terminal electrically connected to the negative electrode terminal of the battery 241. The drive switch 51 is controlled by a control circuit 5.

The control circuit 5 includes, for example, a microcomputer and is configured to output a control signal for controlling the drive switch 51. The control signal outputs the control signal to a gate terminal of the drive switch 51 directly or via a drive circuit to turn on/off the drive switch 51. The control circuit 5 controls the drive switch 51 based on a sensing result by a pressure sensing unit 7 which will be described later to control the rotational speed of the motor 4. Specifically, the control circuit 5 controls the rotational speed of the motor 4 by controlling the drive switch 51 based on, for example, a Pulse Width Modulation (PWM) system with which the duty ratio is adjustable.

Moreover, the control circuit 5 controls the forward reverse switching circuit 40 based on a state of a forward reverse change over switch 222 provided to the grip 22 of the tool body 2. The control circuit 5 controls the forward reverse switching circuit 40 such that the rotation direction of the motor 4 is a rotation direction set by the forward reverse change over switch 222.

Moreover, the control circuit 5 is operated with control electric power supplied from a power source circuit 50. The power source circuit 50 is electrically connected to the battery 241 via the main switch 6. The power source circuit 50 performs direct current conversion of direct-current power supplied from the battery 241 to generate control electric power and supplies the control electric power to the control circuit 5.

As illustrated in FIG. 2, an output shaft 211 protrudes on one side in an axial direction of the body section 21. The output shaft 211 is configured to rotate along with rotation operation of the motor 4. To the output shaft 211, a socket 212 (tip tool) having a cylindrical shape for fastening or loosening fastening components is detachably attached. That is, the motor 4 is configured to receive electric power from the battery 241 to rotate the socket 212. The size of the socket 212 to be attached to the output shaft 211 is accordingly selected by a worker in accordance with the size of a fastening component. The power tool 1 enables work of fastening or loosening fastening components through rotation of the socket 212 by the rotation operation of the motor 4.

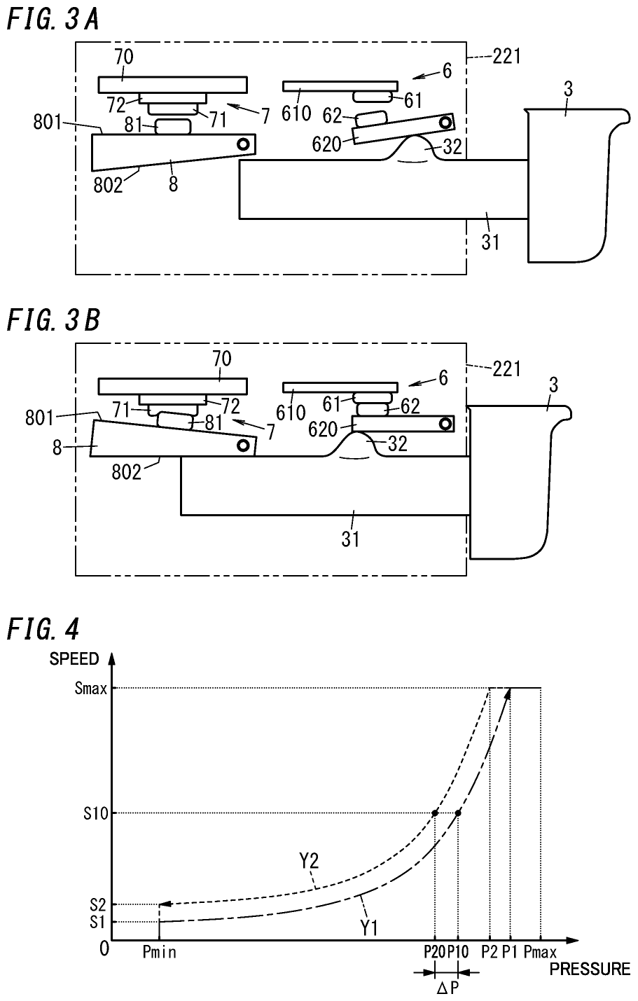

The grip 22 of the tool body 2 is a portion to be gripped by a worker to carry out work and is provided with a trigger 3. The trigger 3 is an operation section for turning on/off the rotation operation of the motor 4 and adjusting the rotational speed of the motor 4 and is configured to be retractable into the grip 22. The trigger 3 is held by the tool body 2 to be movable between an OFF position in which the trigger 3 protrudes from the grip 22 and the pull-in amount is zero (see FIG. 3A) and an ON position in which the trigger 3 is pulled in the grip 22 and the pull-in amount corresponds to an upper limit (see FIG. 3B). The trigger 3 receives force applied by a spring in a direction in which the trigger 3 protrudes from the grip 22.

In the grip 22, a switch box 221 is provided. The switch box 221 accommodates the main switch 6 and the pressure sensing unit 7.

The main switch 6 is a switch for turning on/off electric power supplied from the battery 241 to the motor 4 and the power source circuit 50 and includes a fixed contact 61 and a movable contact 62.

The fixed contact 61 is provided to a fixed contact plate 610. The fixed contact plate 610 is held by the switch box 221. The fixed contact plate 610 is electrically connected to a positive electrode terminal of the motor 4 via a conductive line.

The movable contact 62 is provided to the movable contact plate 620. The movable contact plate 620 is held by the switch box 221 such that one edge side of the movable contact plate 620 serves as a supporting point, and the other edge side of the movable contact plate 620 is movable. The movable contact 62 is provided at the other edge side of the movable contact plate 620 to face the fixed contact 61. The movable contact plate 620 is electrically connected to the positive electrode terminal of the battery 241 via a conductive line. The movable contact plate 620 receives force applied by a spring in a direction in which the movable contact 62 is separated away from the fixed contact 61.

The movable contact plate 620 is configured to be moved by a plunger 31 which has a bar shape and which is connected to the trigger 3. Specifically, the plunger 31 penetrates through a hole formed in the switch box 221 and has one end mechanically connected to the trigger 3. When pulled, the trigger 3 moves to the left in FIGS. 3A and 3B. Thus, when the trigger 3 is pulled, the insertion amount of the plunger 31 into the switch box 221 increases. The plunger 31 has a peripheral surface from which a projection portion 32 protrudes. The trigger 3 is pulled, and the insertion amount of the plunger 31 into the switch box 221 thus increases, and thereby, the projection portion 32 pushes an end of the movable contact plate 620 against the force of the spring to move the end toward the fixed contact plate 610. That is, when the trigger 3 is pulled, the movable contact plate 620 is pushed by the projection portion 32 of the plunger 31, and thereby, the movable contact plate 620 moves toward the fixed contact plate 610.

As illustrated in FIG. 3A, when the trigger 3 is in the OFF position, the projection portion 32 is located in the vicinity of the supporting point of the movable contact plate 620, and the movable contact 62 is thus separated from the fixed contact 61. That is, when the trigger 3 is in the OFF position, the main switch 6 is in an OFF state, and supplying of electric power from the battery 241 to the motor 4 and the power source circuit 50 is interrupted. Moreover, as illustrated in FIG. 3B, when the trigger 3 is in the ON position, the projection portion 32 moves the end of the movable contact plate 620 toward the fixed contact plate 610, thereby bringing the movable contact 62 into contact with the fixed contact 61. That is, when the trigger 3 is in the ON position, the main switch 6 is in an ON state, and the supplying of electric power from the battery 241 to the motor 4 and the power source circuit 50 is performed.

The pressure sensing unit 7 is a switch for adjusting the rotational speed of the motor 4 and includes a pressure receiving unit 71 and a support member 72 which supports the pressure receiving unit 71. The pressure sensing unit 7 is provided to a substrate 70 held by the switch box 221 and is configured to measure the magnitude of pressure received by the pressure receiving unit 71. In the present embodiment, the pressure sensing unit 7 is, for example, a capacitive pressure sensor whose electrostatic capacitance changes in accordance with the magnitude of pressure received by the pressure receiving unit 71. The pressure receiving unit 71 is configured to deform by receiving pressure, and as the pressure received increases, the amount of deformation increases. The pressure sensing unit 7 is configured to change the magnitude of the electrostatic capacitance in accordance with the amount of deformation of the pressure receiving unit 71, and the magnitude of the electrostatic capacitance corresponds to a sensing result (measured pressure) of the magnitude of pressure received by the pressure receiving unit 71. The pressure sensing unit 7 converts the magnitude of the electrostatic capacitance (the magnitude of pressure received by the pressure receiving unit 71) into an electric signal and outputs the electric signal to the control circuit 5, thereby outputting the sensing result (measured pressure) to the control circuit 5. The pressure sensing unit 7 is not limited to the capacitive pressure sensor but may be, for example, a resistive pressure sensor whose resistance value changes in accordance with received pressure.

The pressure sensing unit 7 is disposed to face a movable pressure plate 8 accommodated in the switch box 221. The movable pressure plate 8 has a surface facing the pressure sensing unit 7 and is provided with a pressurizing unit 81 protruding from the surface. The pressurizing unit 81 is made of, for example, hard rubber and is disposed to face the pressure receiving unit 71.

The movable pressure plate 8 is held by the switch box 221 such that one edge side of the movable pressure plate 8 serves as a supporting point, and the other edge side of the movable pressure plate 8 is movable. The movable pressure plate 8 receives force applied by a spring in a direction in which the pressurizing unit 81 is separated away from the pressure receiving unit 71. The movable pressure plate 8 is configured to be pushed by the plunger 31 to move toward the pressure sensing unit 7. Specifically, the movable pressure plate 8 has a trapezoidal section such that the thickness is larger at the other edge side than the one edge side. In other words, the movable pressure plate 8 has a second surface 802 which is tilted with respect to a first surface 801 provided with the pressurizing unit 81 and which is located on an opposite side of the first surface 801. When the trigger 3 is pulled, and the insertion amount of the plunger 31 into the switch box 221 thus increases, a tip end of the plunger 31 comes into contact with the second surface 802 of the movable pressure plate 8. That is, the tip end of the plunger 31 comes into contact with a tilted surface (the second surface 802) of the movable pressure plate 8. Thus, when the insertion amount of the plunger 31 further increases, the tip end of the plunger 31 pushes the movable pressure plate 8 while moving along the second surface 802, so that the movable pressure plate 8 moves toward the pressure sensing unit 7. Thus, the pressurizing unit 81 comes into contact with and applies pressure to the pressure receiving unit 71, thereby deforming the pressure receiving unit 71. Since the second surface 802 of the movable pressure plate 8 is tilted with respect to the first surface 801, the pressure applied to the pressure receiving unit 71 by the pressurizing unit 81 increases as the insertion amount of the plunger 31 increases. That is, when the trigger 3 is pulled, the movable pressure plate 8 is pushed by the tip end of the plunger 31 and moves toward the pressure sensing unit 7, and thus, as the pull-in amount of the trigger 3 increases, the pressure applied to the pressure receiving unit 71 by the pressurizing unit 81 increases. Note that the tip end of the plunger 31 may have an inclined surface configured such that as the insertion amount of the plunger 31 increases, the pressure applied to the pressure receiving unit 71 by the pressurizing unit 81 increases.

Here, when the trigger 3 is pulled in from the OFF position, and the pull-in amount reaches a first pull-in amount, the movable contact 62 comes into contact with the fixed contact 61, so that the main switch 6 transitions to an ON state. When the pull-in amount of the trigger 3 reaches a second pull-in amount larger than the first pull-in amount, the pressurizing unit 81 of the movable pressure plate 8 comes into contact with the pressure receiving unit 71 of the pressure sensing unit 7. Then, as the pull-in amount of the trigger 3 is larger than the second pull-in amount, the pressure applied to the pressure receiving unit 71 by the pressurizing unit 81 is larger. That is, when the trigger 3 is pulled in from the OFF position, the main switch 6 is first turned on, and then, pressure is applied to the pressure sensing unit 7.

As illustrated in FIG. 2, the attachment part 23 of the tool body 2 is formed as a flat parallelepiped, and the battery pack 24 is detachably attached to one surface on an opposite side of the attachment part 23 from the grip 22. The battery pack 24 includes a case 240 (see FIG. 2) formed as a parallelepiped made of a resin, and the battery 241 (e.g., lithium ion battery) is accommodated in the case 240.

The attachment part 23 accommodates the control circuit 5. Moreover, the attachment part 23 is provided with an operation panel 231. The operation panel 231 includes, for example, a plurality of push button switches 232 and a plurality of Light Emitting Diodes (LEDs) 233 and enables, for example, various settings of the power tool 1 to be performed and the state of the power tool 1 to be checked. A worker operates, for example, the operation panel 231 (push button switch 232) to check the residual capacity of the battery 241 and the like. Moreover, the attachment part 23 is provided with a lighting source 234. The lighting source 234 includes, for example, an LED. The lighting source 234 is disposed to irradiate a work location with light during work. The lighting source 234 is configured to emit light when the main switch 6 is turned on.

Next, control of the rotational speed of the motor 4 by the control circuit 5 will be described with reference to FIG. 4. The control circuit 5 controls the drive switch 51 such that as the measured pressure measured by the pressure sensing unit 7 (pressure received by the pressure receiving unit 71) increases, the rotational speed of the motor 4 increases.

Specifically, the control circuit 5 performs sampling of the measured pressure at a prescribed cycle and determines whether the measured pressure increases or decreases with time. That is, the control circuit 5 determines whether the trigger 3 is pulled toward the ON position or returned toward the OFF position.

The control circuit 5 is configured to perform hysteresis control of the rotational speed of the motor 4 such that the rotational speed of the motor 4 with respect to an identical measured pressure value differs between a case where the measured pressure increases with time and a case where the measured pressure decreases with time. FIG. 4 is a graph of a characteristic curve illustrating the rotational speed of the motor 4 with respect to the measured pressure. In FIG. 4, Y1 is a pressurizing characteristic curve illustrating the rotational speed of the motor 4 with respect to the measured pressure in the case where the measured pressure increases with time. In FIG. 4, Y2 is a depressurizing characteristic curve illustrating the rotational speed of the motor 4 with respect to the measured pressure in the case where the measured pressure decreases with time.

As the pressurizing characteristic curve Y1 shows, when the measured pressure is increased from a lower limit value Pmin to an upper limit value Pmax, the rotational speed of the motor 4 continuously increases from speed S1. When the measured pressure reaches a pressure value P1, the rotational speed of the motor 4 corresponds to an upper limit value Smax, and while the measured pressure is in a range from the pressure value P1 to the upper limit value Pmax, the rotational speed of the motor 4 is maintained at the upper limit value Smax.

As the depressurization characteristic curve Y2 shows, when the measured pressure is reduced from the upper limit value Pmax to the lower limit value Pmin, the rotational speed is maintained at the upper limit value Smax while the measured pressure is in a range from the upper limit value Pmax to a pressure value P2. The pressure value P2 is a value smaller than the pressure value P1. When the measured pressure decreases from the pressure value P2, the rotational speed of the motor 4 continuously decreases from the upper limit value Smax to speed S2, and when the measured pressure reaches the lower limit value Pmin, the rotational speed of the motor 4 becomes zero, that is, the motor 4 stops. The speed S2 is higher than the speed S1.

The lower limit value Pmin of the measured pressure is zero. That is, measured pressure corresponding to the lower limit value Pmin shows that the pull-in amount of the trigger 3 is within a range from zero (OFF position) to the second pull-in amount. Moreover, measured pressure corresponding to the upper limit value Pmax shows that the trigger 3 is in the ON position.

As illustrated in FIG. 4, the case where the measured pressure increases with time is compared with the case where the measured pressure decreases with time. In this case, in a range of the measured pressure from the lower limit value Pmin to the pressure value P1, the rotational speed of the motor 4 with respect the measured pressure is always larger in the case where the measured pressure decreases with time than in the case where the measured pressure increases with time. Thus, hysteresis control of the rotational speed of the motor 4 is performed.

The control circuit 5 controls the rotational speed of the motor 4 in accordance with a change in the measured pressure with time along the pressurizing characteristic curve Y1 or the depressurization characteristic curve Y2.

Moreover, the control circuit 5 maintains the rotational speed of the motor 4 at a constant speed also when the measured pressure increases and decreases within a prescribed range. For example, it is assumed that the measured pressure increases from the lower limit value Pmin to a pressure value P10 (<pressure value P1). In this case, the control circuit 5 increases the rotational speed of the motor 4 to speed S10 along the pressurizing characteristic curve Y1. Here, in the depressurization characteristic curve Y2, it is assumed that the measured pressure in a case of the rotational speed of the motor 4 being the speed S10 corresponds to a pressure value P20 (<pressure value P10). The control circuit 5 maintains the rotational speed of the motor 4 at the speed S10 while the measured pressure decreases from the pressure value P10 to the pressure value P20 on the depressurization characteristic curve Y2. Moreover, the control circuit 5 maintains the rotational speed of the motor 4 at the speed S10 also when the measured pressure increases between the pressure value P20 and the pressure value P10. That is, the control circuit 5 maintains the rotational speed of the motor 4 at the speed S10 when the measured pressure increases and decreases within a range ΔP between the pressure value P20 and the pressure value P10. Thus, even when the pull-in amount of the trigger 3 is changed by vibration caused due to work with the power tool 1, the rotational speed of the motor 4 is maintained at a constant speed as long as a change of the measured pressure caused due to a change of the pull-in amount of the trigger 3 is within the range ΔP.

That is, when the rotational speed of the motor 4 is speed Sx within a range of the measured pressure from the lower limit value Pmin to the pressure value P1, the control circuit 5 maintains the rotational speed of the motor 4 at the speed Sx even when the measured pressure changes within a range ΔPx. The range ΔPx is a range between a pressure value Px1 where the rotational speed of the motor 4 is the speed Sx on the pressurizing characteristic curve Y1 and a pressure value Px2 where the rotational speed of the motor 4 is the speed Sx on the depressurization characteristic curve Y2.

Moreover, when the measured pressure decreases below the pressure value P20, the control circuit 5 reduces the rotational speed of the motor 4 from the speed S10 along the depressurization characteristic curve Y2. Alternatively, when the measured pressure increases above the pressure value P10, the control circuit 5 increases the rotational speed of the motor 4 from the speed S10 along the pressurizing characteristic curve Y1.

In the above-described example, the power tool 1 as an electric wrench has been described, but the power tool 1 is not limited to the electric wrench but may be another power tool, such as an electric driver and an electric drill, which includes the motor 4.

As described above, a power tool 1 of a first aspect includes a motor 4, a trigger 3, a pressure sensing unit 7, and a control circuit 5. The motor 4 is configured to receive electric power from a battery 241 (power supply) to rotate a socket 212 (tip tool). The trigger 3 is movably held by a tool body 2. The pressure sensing unit 7 includes a pressure receiving unit 71 for receiving pressure according to a pull-in amount of the trigger 3 and is configured to measure a magnitude of the pressure received with the pressure receiving unit 71. The control circuit 5 is configured to control a rotational speed of the motor 4 based on measured pressure measured by the pressure sensing unit 7. The control circuit 5 is configured to perform hysteresis control of the rotational speed of the motor 4 such that the rotational speed of the motor 4 with respect to the measured pressure differs between a case where the measured pressure increases with time and a case where the measured pressure decreases with time.

This configuration enables the power tool 1 to suppress a change of and stabilize the rotational speed of the motor 4 even when the pull-in amount of the trigger 3 is changed by, for example, vibration caused due to work with the power tool 1 or pulsation of a finger with which the trigger 3 is pulled.

In a power tool 1 according to a second aspect referring to the first aspect, the control circuit 5 preferably performs the hysteresis control of the rotational speed of the motor 4 such that the rotational speed of the motor 4 with respect to the measured pressure is higher in a case where the measured pressure decreases with time than in the case where the measured pressure increases with time.

This configuration enables the power tool 1 to maintain the rotational speed of the motor 4 as long as a change amount of the pull-in amount of the trigger 3 is within a prescribed range even in a case where the change of the pull-in amount of the trigger 3 transitions from an increase to a decrease and in a case where the change of the pull-in amount of the trigger 3 transitions from the decrease to the increase.

### REFERENCE SIGNS LIST

1 POWER TOOL
2 TOOL BODY
212 SOCKET (TIP TOOL)
241 BATTERY (POWER SUPPLY)
3 TRIGGER
4 MOTOR
5 CONTROL CIRCUIT
7 PRESSURE SENSING UNIT
71 PRESSURE RECEIVING UNIT

1. A power tool, comprising:
a motor configured to receive electric power from a power supply to rotate a tip tool;
a trigger movably held by a tool body;
a pressure sensing unit which includes a pressure receiving unit for receiving pressure according to a pull-in amount of the trigger and is configured to measure a magnitude of the pressure received with the pressure receiving unit; and
a control circuit configured to control a rotational speed of the motor based on measured pressure measured by the pressure sensing unit,
the control circuit being configured to perform hysteresis control of the rotational speed of the motor such that the rotational speed of the motor with respect to the measured pressure differs between a case where the measured pressure increases with time and a case where the measured pressure decreases with time.

2. The power tool of claim 1 wherein
the control circuit performs the hysteresis control of the rotational speed of the motor such that the rotational speed of the motor with respect to the measured pressure is higher in a case where the measured pressure decreases with time than in the case where the measured pressure increases with time.
